(19) United States
(12) Patent Application Publication
(10) Pub. No.: US 2004/0081141 A1
(43) Pub. Date: Apr. 29, 2004

(54) Digital subscriber line device and method of processing dial string thereby

(75) Inventors: Ming-Chieh Chen, Hsinchu (TW); Shu-Ken Lin, Hsinchu (TW)

Correspondence Address: Richard P. Berg, Esq., c/o LADAS & PARRY, Suite 2100, 5670 Wilshire Boulevard, Los Angeles, CA, 90036-5679, US

(73) Assignee: Ambit Microsystems Corporation

(21) Appl. No.: 10/650,149

(22) Filed: Aug. 27, 2003

(30) Foreign Application Priority Data
Oct. 9, 2002 (TW) 91123321

(51) Int. Cl. H04L 12/66

(52) U.S. Cl. 370/352

(57) ABSTRACT

A method for a digital subscriber line device to process dial string. The digital subscriber line device is coupled to a PSTN (public switched telephone network) and a VoIP network. First, a transmission is received by the digital subscriber line device. Then, the dial string of the transmission is compared with phone numbers stored in a PSTN digit map and in a VoIP digit map by a PSTN digit string processor and a VoIP digit string processor, respectively. The transmission is routed to the PSTN network when a phone number corresponding to the transmission is found in the PSTN digit map. The transmission is routed to the VoIP network when a phone number corresponding to the transmission is found in the VoIP digit map.

### BACKGROUND OF THE INVENTION

1. Field of the Invention

The present invention relates to an application for telephone communication service and particularly to a digital subscriber line device and method of processing dial string thereby, which also supports public switched telephone networking (PSTN) and VoIP (Voice-over-Internet Protocol) services at the same time.

2. Description of the Prior Art

Several communication technologies provide different telephone communication services. Telephone communication services comprise POTS (Plain Old Telephone Service) and VoIP (Voice-over-Internet Protocol) service. POTS is popular for standard telephone communications. When one telephone is coupled to the PSTN (public switched telephone network), the user of the telephone is served by POTS. VoIP is a protocol for transmitting voice and image packets through an open network to provide telephone communication service. The benefit of VoIP service is that subscribers can pay a local dial-up fee and achieve long distance call service via Internet access, when a call agent exists in the service, providing decreased telephone fees. The drawback is that the communication quality is not stable. If Internet service or a call agent is not available or system noise is prohibitive, for example, communication quality is compromised. Telephone fees for POTS are much higher than VoIP service, but the communication quality is more stable in the network environment today.

Products providing telephone communication service on the market cannot support POTS and VoIP service at the same time, such that users must provide a separate dedicated telephone system for each protocol, thereby presenting considerable inconvenience.

### SUMMARY OF THE INVENTION

The object of the present invention is to provide a method for a digital subscriber line device to process dial string. Using the method, the digital subscriber line device also transmits dial string to the PSTN network and the VoIP network at the same time.

An object of the present invention is to provide a digital subscriber line device using the above method. A single telephone system can provide VoIP service and PSTN service when the VoIP service is unavailable. Users can set specific telephone numbers for transmission through PSTN networks only. Telephone fees are thus reduced and convenience is increased.

The present invention provides a method for a digital subscriber line device to process dial string. The digital subscriber line device is coupled to a PSTN (public switched telephone network) and a VoIP network. First, a transmission is received by the digital subscriber line device. Then, the dial string of the transmission is compared with phone numbers stored in a PSTN digit map and in a VoIP digit map by a PSTN digit string processor and a VoIP digit string processor, respectively. The transmission is routed to the PSTN network when a phone number corresponding to the dial string of the transmission is found in the PSTN digit map. The transmission is routed to the VoIP network when a phone number corresponding to the transmission is found in the VoIP digit map.

Furthermore, the present invention also provides a digital subscriber line device. The digital subscriber line device comprises at least one first port, a second port, a PSTN digit map, a VoIP digit map, a PSTN digit map processor and a VoIP digit map processor. The first port is coupled to a PSTN network. The second port is coupled to a VoIP network. The PSTN digit map processor compares the dial string of a transmission received by the digital subscriber line device with phone numbers stored in the PSTN digit map. If a phone number corresponds to the dial string of the transmission in the PSTN digit map, the PSTN digit map processor routes the transmission to the PSTN network through the first port. The VoIP digit map processor compares a transmission received by the digital subscriber line device with phone numbers stored in the VoIP digit map. If a phone number corresponds to the dial string of the transmission in the VoIP digit map, the VoIP digit map processor routes the transmission to the VoIP network through the second port.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a flowchart illustrating a method for a digital subscriber line device to process a dial string according to the first embodiment of the present invention.

FIG. 2 is a block diagram illustrating a digital subscriber line device according to the first embodiment invention.

FIG. 3 is the structure of the telephone system comprising the digital subscriber line device shown in FIG. 2.

FIG. 4 is a flowchart illustrating a method for a digital subscriber line device to process a dial string according to the second embodiment of the present invention.

### DETAILED DESCRIPTION OF THE INVENTION

The present invention discloses a method for a digital subscriber line device to process dial string. Using the method of the present invention, the digital subscriber line device can also transmits a dial string to the PSTN network and the VoIP network at the same time. The present invention also discloses a digital subscriber line device using the above method. Users can use one telephone to make a VoIP call or a PSTN call when VoIP service is unavailable. Users can also set specific telephone numbers as exclusive phone numbers to PSTN to be routed through the PSTN network. Accordingly, telephone fees are reduced and convenience is increased. The following embodiment is described in detail with reference to the figures.

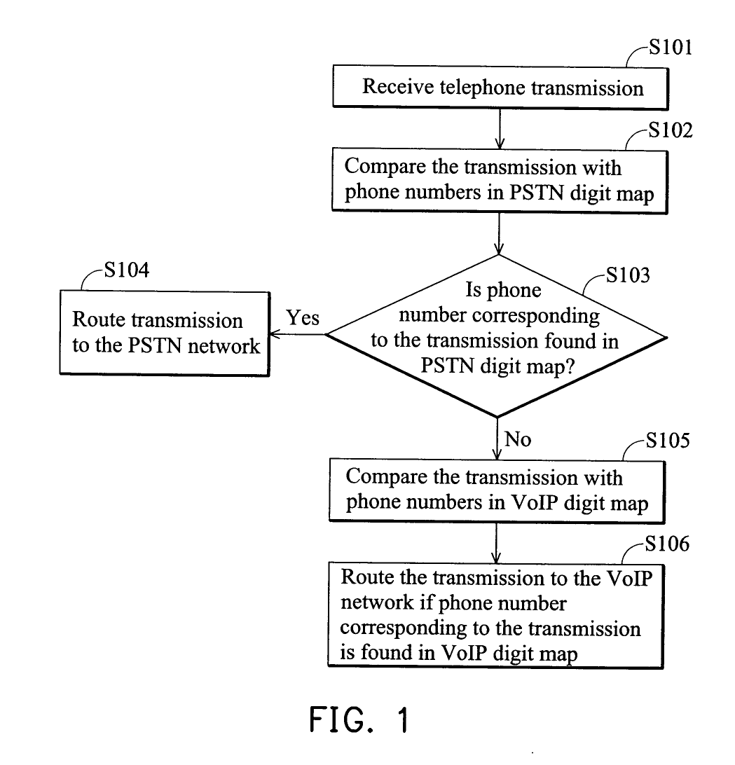

FIG. 1 is a flowchart illustrating a method for a digital subscriber line device to process dial string according to the first embodiment of the present invention. As shown in FIG. 1, a transmission is received by the digital subscriber line device first (s101). Then, the digital string transmission is compared with the phone numbers stored in a PSTN digit map by a PSTN digit string processor (S102). It is checked whether a phone number corresponding to the dial string of the transmission is found in the PSTN digit map (S103). If the phone number corresponding to the dial string of the transmission is found in the PSTN digit map, the transmission is routed to the PSTN network (S104). If the phone number corresponding to the dial string of the transmission is not found in the PSTN digit map, the transmission is compared with the phone numbers stored in a VoIP digit map by a VoIP digit string processor (S105). Finally, the transmission is routed to the VoIP network when a phone number corresponding to the dial string of the transmission is found in the VoIP digit map (S106).

In the embodiment of the present invention, the digital subscriber line device that uses the PSTN digit string processor to compare the dial string of the transmission with the phone numbers stored in the PSTN digit map before using the VoIP digit string processor to compare the dial string of the transmission with phone numbers stored in the VoIP digit map is taken as an example. In other embodiments, other digital subscriber line devices with different comparing order can replace it.

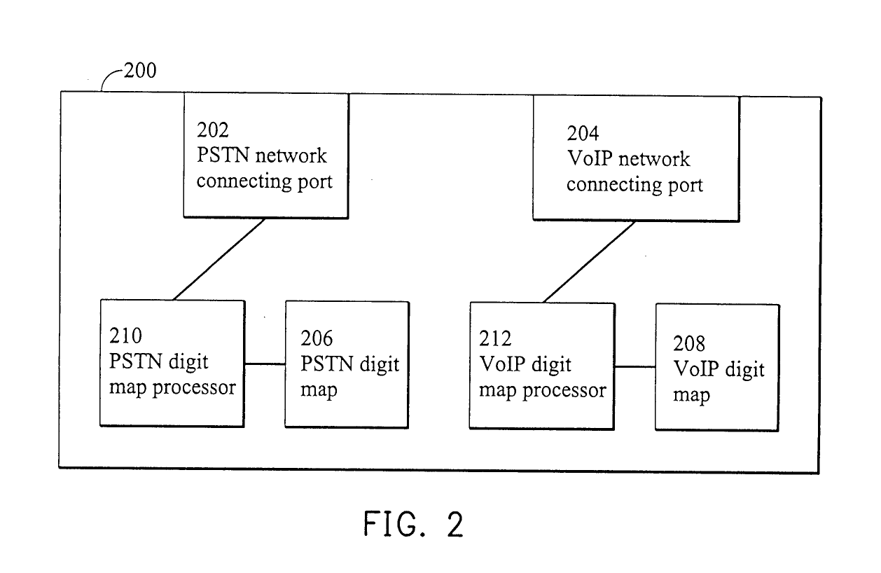

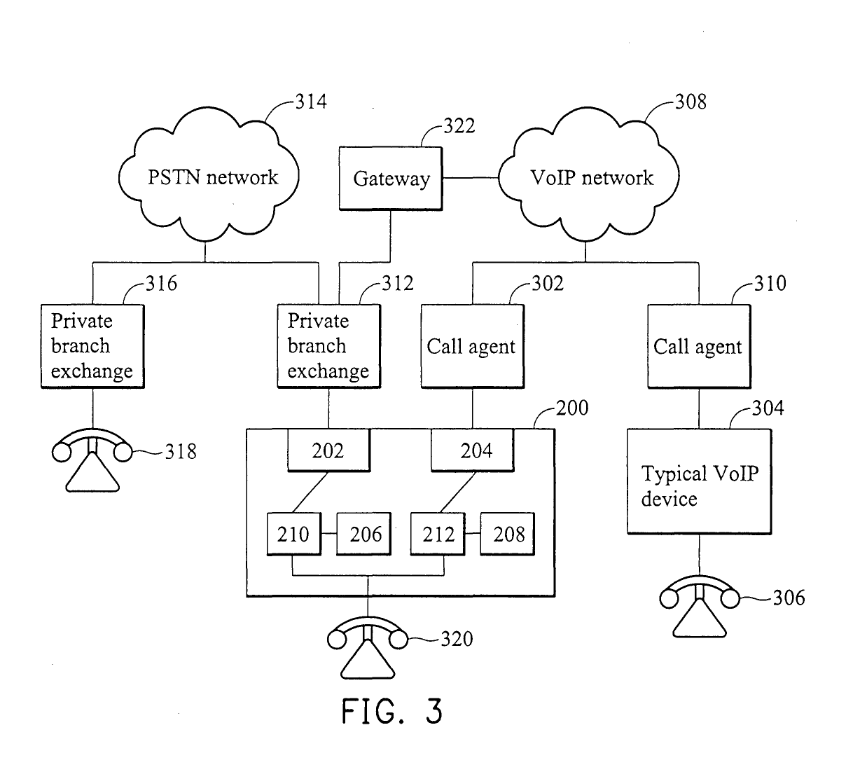

FIG. 2 is a block diagram illustrating a digital subscriber line device according to the first embodiment invention. FIG. 3 is the structure of the telephone system comprising the digital subscriber line device shown in FIG. 2. Referring to FIG. 2 and FIG. 3 at the same time, the digital subscriber line device 200 comprises at least one PSTN network connecting port 202, a VoIP network connecting port 204, a PSTN digit map 206, a VoIP digit map 208, a PSTN digit map processor 210 and a VoIP digit map processor 212. Each of the PSTN network connecting port 202 is coupled to a PSTN network 314 through a PBX (private branch exchange) 312. The VoIP network connecting port 204 is coupled to a VoIP network 308 through a call agent 302. The VoIP network 305 communicates with the PSTN network 314 through a gateway 322. Phone numbers stored in the VoIP digit map 208 are set according to user requirements. The VoIP digit map 208 is stored in the digital subscriber line device 200 through the call agent 302. The user can set specific telephone numbers as exclusive phone numbers to PSTN to be stored in the PSTN digit map 210 and routed through the PSTN network 314. The VoIP digit map 208 is stored in the digital subscriber line device 200 through the call agent 302.

The digital subscriber line device 200 is coupled to at least one telephone 320 and receives a transmission therefrom. If the user applies several VoIP numbers for a company to provide VoIP service, the digital subscriber line device can be coupled to a plurality of telephones. In the present embodiment, a digital subscriber line device that is coupled to only one telephone is used as an example.

The PSTN digit map processor 210 compares the transmission received by the digital subscriber line device 200 with the phone numbers stored in the PSTN digit map 206. If a phone number in the PSTN digit map 206 corresponds to the dial string of the transmission, the PSTN digit map processor 210 routes the transmission to the PSTN network 314 through the PSTN network connecting port 202.

The VoIP digit map processor 212 compares the dial string of the transmission with the phone numbers stored in the VoIP digit map 208. If a phone number in the VoIP digit map 208 corresponds to the transmission, the VoIP digit map processor 212 routes the transmission to the VoIP network 308 through the VoIP network connecting port 204.

As shown in FIG. 3, a typical telephone 318 is coupled to the PSTN network 314 through a local PBX 316. Another telephone 306 is coupled to a typical VoIP device 304, and then coupled to the VoIP network 308 through a local call agent 310. Using the digital subscriber line device 200, the user of the telephone 320 can selectively communicate with the users of the telephones 306 and 318 through the PSTN network 314 and the VoIP network 308, respectively.

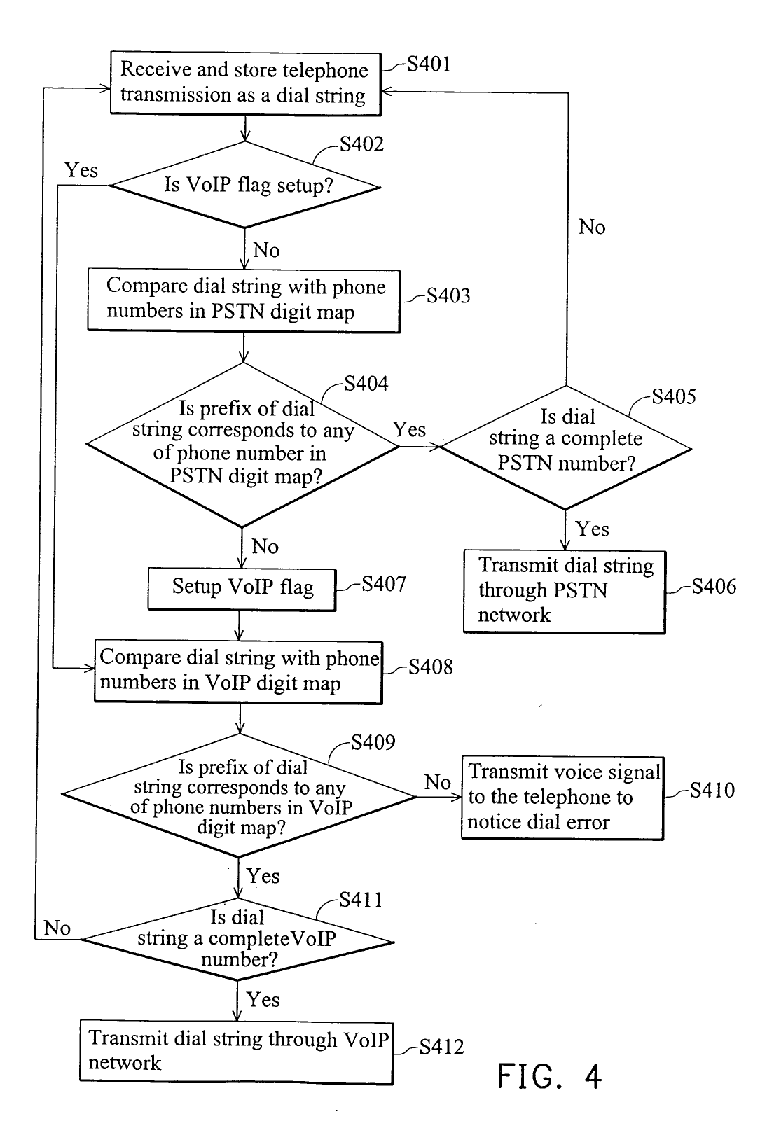

FIG. 4 is a flowchart illustrating a method for a digital subscriber line device to process dial string according to the second embodiment of the present invention. In the embodiment, the digital subscriber line device uses the PSTN digit string processor to compare the dial string of the transmission with the phone numbers stored in the PSTN digit map before using the VoIP digit string processor to compare the dial string of the transmission with phone numbers stored in the VoIP digit map. As shown in FIG. 4, first, the digital subscriber line device receives a telephone transmission from a telephone and stores the telephone transmission as a dial string (s401). Then, the digital subscriber line device checks whether a VoIP flag is setup (S402). If the VoIP flag is setup, the process proceeds to step S408.

If the VoIP flag is not set up, the PSTN digit string processor in the digital subscriber line device compares the dial string with the phone numbers stored in a PSTN digit map (S403). Then, it is checked whether the prefix of the dial string is corresponding to a phone number found in the PSTN digit map (S404). If the prefix of the dial string is corresponding to a phone number in the PSTN digit map, it is checked whether the dial string is a complete PSTN number (S405). If the dial string is a complete PSTN number, the digital subscriber line device transmits the dial string through the PSTN network (S406). If the dial string is not a complete PSTN number, step S401 is repeated.

If no prefix of the dial string is corresponding to any of the phone numbers in the PSTN digit map, the digital subscriber line device sets up the VoIP flag first (S407). Then, the VoIP digit string processor in the digital subscriber line device compares the dial string with the phone numbers stored in a VoIP digit map (S408). Then, it is checked whether the prefix of the dial string is corresponding to the phone numbers in the VoIP digit map (S409). If no prefix of the dial string is corresponding to any of the phone numbers in the VoIP digit map, the digital subscriber line device transmits a voice signal to the telephone to notify the user of a dial error message (S410). If the prefix of the dial string is corresponding to a phone number in the VoIP digit map, it is checked whether the dial string is a complete VoIP phone number (S411). If the dial string is a complete VoIP number, the digital subscriber line device transmits the dial string through the VoIP network (S412). If the dial string is not a complete VoIP phone number, repeat the step S401.

To more fully understand the above procedure, the processing of the phone number of 911 being dialed by the user is used as example. 911 is recognized as an important emergency number. 911 is then set as a complete PSTN number and stored in the PSTN digit map by the user. According to the above procedure, when the digital subscriber line device receives the dialed digit “9” from the telephone, the digital subscriber line device performs steps S401˜S405 in order. When the digital subscriber line device receives the dialed digit “1”, the digital subscriber line device also performs steps S401˜S405 in order. Finally, when the digital subscriber line device receives the dialed digit “1” again, the digital subscriber line device performs steps S401˜S406 in order.

Using the method for a digital subscriber line device to process dial string provided by the invention, the digital subscriber line device also transmits dial string to the PSTN network at the same time. Users can use one telephone to make a VoIP call and make a PSTN call when VoIP service is unavailable. Users can also set specific telephone numbers as exclusive numbers to PSTN to be routed through the PSTN network. Thus, telephone fees are reduced and convenience is increased.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for a digital subscriber line device to process a dial string wherein the digital subscriber line device is coupled to a PSTN (public switched telephone network) and a VoIP (Voice-over-Internet Protocol) network, the method comprising:
receiving a transmission by the digital subscriber line device;
comparing a dial string of the transmission with phone numbers stored in a PSTN digit map and a VoIP digit map by a PSTN digit string processor and a VoIP digit string processor, respectively;
routing the transmission to the PSTN network when a phone number corresponding to the transmission is found in the PSTN digit map; and
routing the transmission to the VoIP network when a phone number corresponding to the transmission is found in the VoIP digit map.

2. The method as claimed in claim 1, wherein the PSTN digit map is configured manually and stored in the digital subscriber line device.

3. The method as claimed in claim 1, wherein the VoIP digit map is configured by a call agent and stored in the VoIP device.

4. The method as claimed in claim 1, wherein the transmission is routed from a telephone to the digital subscriber line device.

5. A digital subscriber line device comprising:
at least one first port coupled to a PSTN network;
a second port coupled to a VoIP network;
a PSTN digit map;
a VoIP digit map;
a PSTN digit map processor for comparing a transmission received by the digital subscriber line device with phone numbers stored in the PSTN digit map, wherein when a phone number corresponds to the transmission is found in the PSTN digit map, the PSTN digit map processor routes the transmission to the PSTN network through the first port; and
a VoIP digit map processor for comparing a transmission received by the digital subscriber line device with phone numbers stored in the VoIP digit map, wherein when a phone number corresponds to the transmission is found in the VoIP digit map, the VoIP digit map processor routes the transmission to the VoIP network through the second port.

6. The digital subscriber line device as claimed in claim 5, wherein the PSTN digit map is configured manually and stored in the digital subscriber line device.

7. The digital subscriber line device as claimed in claim 5, wherein the VoIP digit map is configured by a call agent and stored in the digital subscriber line device.

8. The digital subscriber line device as claimed in claim 5, wherein the dial-up transmission is routed from a telephone to the digital subscriber line device.
